(19) United States
(12) Patent Application Publication
(10) Pub. No.: US 2007/0160736 A1
(43) Pub. Date: Jul. 12, 2007

(54) Brewable coffee product

(76) Inventor: Jon Day, Layton, UT (US)

Correspondence Address: LAW OFFICE OF BRIAN R. RAYVE, P.O Box 11586, Salt Lake City, UT, 84147-0586, US

(21) Appl. No.: 10/770,179

(22) Filed: Jan. 31, 2004

(51) Int. Cl. A23F 5/00

(52) U.S. Cl. 426/595

(57) ABSTRACT

A brewable coffee product usable to produce a coffee beverage. A first version coffee product includes ground roasted coffee, cocoa, a vanilla flavoring ingredient, and wheat, oats, corn, or barley flakes, or combinations thereof. One or more additional flavoring ingredients may be included such as mint, cinnamon, peppermint, or maple syrup. The coffee product may be individually packaged for single cup dipping. A second version of the coffee product includes ground roasted coffee and a plurality of elongate, non-toxic flow-facilitating members in the form of spaghetti, macaroni, noodles, or a combination thereof which facilitate flow of brewing water through the product during drip brewing. The pasta product also raises the pH of the coffee beverage brewed therewith to reduce acidity thereof.

### BACKGROUND OF THE INVENTION

1. Field

The present invention relates to granular coffee products for use in brewing coffee beverages and more particularly to such granular coffee products comprised of ground roasted coffee mixed with one or more additional ingredients for use brewing coffee beverages.

2. State of the Art

Coffee is a widely enjoyed beverage which is brewed from ground roasted coffee beans which has an enjoyable taste and a pleasant aroma. Coffee is particularly consumed by people in the morning to wake up such as at work, and in the evenings to stay awake due to the presence of the stimulant caffeine contained therein.

Coffee is brewed in the older percolator coffee makers, though now mostly brewed in the modern automatic drip coffee makers. In the drip coffee makers, ground roasted coffee beans are retained in a pleated cup-shaped paper filter disposed in a hollow brewing basket defining an open-ended brewing chamber. A quantity of cold water equal to the capacity of an associated coffee pot or carafe is added to a tank of the coffee maker which feeds the water through a coiled heating tube using electrical resistance heating to raise the temperature of the water to near boiling. The hot brewing water exits the heating tube onto the ground coffee beans contained within the filter in the brewing chamber. The brewing water seeps through the ground coffee extracting the numerous compounds which produce the desirable taste and smell of the extracted coffee beverage. The brewing water with extracted compounds, or brewed coffee, passes through an outlet hole through a bottom wall of the brewing basket into the carafe disposed therebelow. When the extraction process is completed, the carafe is removed from the coffee maker and used to pour the brewed coffee into coffee cups for individual consumption. A major problem with conventional coffee is its tendency to produce stomach acid by physically being of an acidic pH and by causing excess acid to be produced by the drinker's stomach.

While coffee is generally brewed from 100% ground roasted coffee beans, various additives have been used to replace some of the coffee beans to change the flavor and color of the brewed coffee. This is particularly useful to mask the somewhat acidic tendencies of pure ground coffee, which typically is between about 5.6 to 5.8 pH (5.5 pH being highly acidic and 8.0 pH being highly alkali). One such additive is roasted chicory which has a distinctive flavor and which darkens the brewed coffee. Various filler materials of lower cost than coffee beans and without the caffeine have also been used to replace some of the ground coffee beans to lower the cost of the ground coffee and reduce the caffeine content of the brewed coffee. One such filler is roasted grains such as wheat.

There are numerous patents on coffee products at least partially comprised of ground coffee for brewing coffee beverages. For example, in U.S. Pat. No. 4,188,409 issued to Kay on Feb. 12, 1980 is disclosed a granular coffee product used for brewing a coffee beverage. The coffee product is made from roasted coffee which is ground, mixed with water, and coated onto ground nut shells. The coated nut shells are dried to produce a granular coffee product which looks like conventional coffee. The coffee product produces a coffee beverage that tastes like conventional brewed coffee yet uses only a fraction of the amount of ground coffee normally needed.

In U.S. Pat. No. 4,142,002 issued to Spotholz et al. on Feb. 27, 1979 is disclosed a method for producing a coffee product which reduces brewing problems. The coffee product produced using the method includes roasted wheat combined with ground roasted coffee. Alternatively, the roasted wheat is combined with whole roasted coffee and both are subsequently ground.

In U.S. Pat. No. 4,072,765 issued to Scarsella et al. on Feb. 7, 1978 is disclosed a method for producing another coffee product used to brew a coffee beverage. The coffee product includes on a weight basis from forty to sixty percent roasted coffee, from thirty-five to fifty-five percent roasted and comminuted wheat, and from three to six percent hydrolyzed starch material.

A number of substitutes for coffee have also been developed which contain no coffee whatsoever, and consequently no caffeine. While many people prefer these coffee substitutes due to their taste, these coffee substitutes are especially useful for those persons whom cannot tolerate or do not want to ingest caffeine. The coffee substitutes also tend to cost less than coffee products since coffee is significantly more expensive than the typical ingredients of coffee substitutes.

There are numerous patents on coffee products at least partially comprised of ground coffee for brewing coffee beverages. For example, in U.S. Pat. No. 6,171,635 issued to Zhao on Jan. 9, 2001 is disclosed a coffee substitute made from grain and legume which is lightly roasted. The coffee substitute can be used as a carrier of nutritional supplements or as an additive to coffee, tea, or chocolate. The brewed coffee substitute is especially made for persons who should not drink regular coffee, such as pregnant women, or persons who suffer from certain medical conditions.

In U.S. Pat. No. 3,966,995 issued to Workman on Jun. 29, 1976 is disclosed a coffee substitute made from carrot roots. The tops of the whole carrots are chopped off, the remaining carrot root is peeled, and an outer zone or cortex of the carrot root is separated from a central zone of wood and pith. The central zone contains the material responsible for the characteristic carrot odor which is not desirable for brewing. The separated cortex is subdivided such as by grating or by paring into thin strips by means using a potato peeler, dried, and roasted in an oven until dark brown. The resulting coffee substitute is subsequently brewed in a drip coffee maker using the same proportions of coffee substitute to hot water as would be used in brewing regular coffee to produce a simulated coffee beverage.

In U.S. Pat. No. 175,970 issued to Gravel on Apr. 11, 1876 is disclosed a composition for coating roasted coffee which helps to prevent deterioration of the coffee. The coated coffee is produced by combining ingredients including roasted coffee, dextrine, cornmeal or wheat-flour, cocoa, and water. The ingredients are mixed together while boiling forming a pasty mass in which the cocoa and dextrine produce a compound that uniformly coats the coffee so the aroma of the coffee cannot escape as quickly. This helps to prevent deterioration of the coffee such that the flavor of the coffee beverage brewed therefrom is improved. The cocoa adds color to the composition similar to coffee and improves the flavor of the dextrine.

A major problem with the use of additives and filler materials in coffee products and coffee substitutes is a marked increase in the time needed for the hot brewing water to drain from the basket of drip coffee makers. Some of the brewing water may even be completely stopped from exiting the brewing chamber as brewing of the ground coffee with additives or fillers proceeds. Generally speaking, the higher the proportion of additives and fillers relative to the coffee, the slower the brewing water flows through the ground mixture. Likewise, the finer the additives, fillers, and coffee are ground, the slower the brewing water moves through the ground mixture. Conversely, some finely ground mixtures can form channels therethrough which causes rapid draining and extraction of only a small proportion of the ground mixture. The resultant brewed coffee beverage is then drastically weakened.

Various attempts have been made to alleviate the clogging problem of drip coffee makers. Some of these attempts involve modifications to the coffee maker itself. Most have revolved around supporting the paper filter above the bottom of the brew chamber. This minimizes resistance of the brewing water with extracted coffee flowing to the outlet hole by allowing it to flow freely under the paper filter and through the outlet hole of the brewing basket. For example, in U.S. Pat. No. 4,739,697 issued to Roberts on Apr. 26, 1988 is disclosed a brewing basket with a filter spacer and a support frame for drip coffee makers. The support frame is resiliently engagable within the brew chamber spaced from the bottom thereof. A paper filter is received within the brew chamber in conventional fashion for receipt of the ground coffee. During the brewing process, the filter is supported above the bottom so as not to sag to prevent clogging of the brew chamber. The brewing basket is made of stainless steel rather than the more conventionally used plastic.

While the above-mentioned drip coffee makers, coffee products, and coffee substitutes attempt to solve the problems associated with producing good brewed coffee and coffee substitutes, there is considerable room for improvement. Firstly, while some drip coffee makers utilize brewing baskets which space the paper filter from the bottom thereof so as to facilitate passage of the brewing water with extracted coffee to the outlet hole, such arrangements are not the norm. Additionally, these brewing baskets do not work if the brewing water cannot pass through the coffee, coffee product, or coffee substitute at a proper rate. Finely ground coffee as well as the normally ground coffee products and substitutes are still troublesome. Secondly, the coffee and coffee products of the prior art tend to produce a brewed coffee beverage which is acidic due to the nature of the ground coffee beans. Acidic coffee beverages are bitter and the prior art only masks the bitterness using other ingredients.

There is therefore a need for an improved coffee product for brewing an improved coffee beverage which: 1) facilitates the flow of the brewing water so as not to plug up during brewing in drip coffee makers; and 2) is acid neutralizing to produce a brewed coffee beverage which is naturally non-bitter, being an “alkalizing” food rather than an acid-forming food which causes the person's stomach to produce acid as regular coffee does. Additionally, it is desirable that the improved coffee product: 3) be made from natural ingredients and thus healthier to drink; 4) be smooth and have a slightly different pleasing flavor; 5) be economical to produce; and 6) have a low number of ingredients; and be packagable in multiple formats such as canisters, foil bags, and single use dunking bags similar to tea bags.

### SUMMARY OF THE INVENTION

The present invention is a brewable coffee product usable to produce a coffee beverage.

A first embodiment of the coffee product includes ground roasted coffee, cocoa, and a vanilla flavoring ingredient. A preferred first embodiment coffee product further comprises flour in the form of wheat, oats, corn, or barley grain flakes, or combinations thereof. There is between about 35 to 45 volume percent ground roasted coffee, between about 10 to 20 volume percent cocoa, between about 0 to 10 volume percent vanilla flavoring ingredient, and between about 35 to 45 volume percent grain flakes. At least one additional flavoring ingredient may be included such as mint, cinnamon, peppermint, or maple syrup. The coffee product may be individually packaged for single cup dipping.

A second embodiment of the coffee product includes ground roasted coffee and a plurality of elongate, non-toxic flow-facilitating members adapted to facilitate flow of brewing water through the product during brewing. In a preferred second embodiment coffee product the flow facilitating members comprise a pasta product such as spaghetti, macaroni, noodles, or a combination of at least two thereof. The pasta product may include Amaranth flour if desired. There is between about 50 to 70 volume percent ground roasted coffee and between about 30 to 50 volume percent pasta product. The pasta product raise the pH of the coffee beverage brewed therewith to reduce acidity thereof and produce a more alkaline food than regular coffee.

### DETAILED DESCRIPTION OF THE ILLUSTRATED EMBODIMENTS

The brewable coffee products of the present invention include ground roasted coffee of any desired single type or blend thereof commercially available such as Columbian, French Roast, Arabica, or Robustas to produce a coffee beverage. The ground roasted coffee may be caffeinated or decaffeinated as is known in the industry and prepared by percolating, drip brewing, or dipping as done with tea bags. The coffees may be from lighter roast to a darker roast as desired. The ground coffee typically has a particle size in the mesh range of about 8 to 16 for standard percolator coffee makers, in the mesh range of about 12 to 24 for automatic drip coffee makers, and in the mesh range of about 20 to 36 for European coffee brewing.

All proportions, amounts, parts, ratios and percentages used herein are by volume unless otherwise specified.

### First Embodiment Brewable Coffee Product

A first embodiment brewable coffee product includes the ground roasted coffee described, cocoa, and a vanilla flavoring ingredient.

The cocoa is any of a variety of commercially available cocoa. The cocoa used may be natural chocolate, acid neutralized Dutched chocolate, or fermented cocoa. Dutched chocolate is prepared by treating the raw cocoa nibs with a food grade alkaline material such as sodium bicarbonate. Cocoa made using dutched chocolate is of a darker color and also can be more flavorful than natural cocoas. Fermented cocoa is prepared by fermenting green cocoa beans before roasting and milling. The fermentation is usually conducted by soaking the green beans in water for a week and then drying. A substantial portion of the fat or cocoa butter has been removed from the cocoa by solvent extraction, by pressing, or the like. Therefore, chocolate can be used as the cocoa source and is thus encompassed by the term “cocoa.” Chocolate should be finely ground or divided when used as the cocoa.

The vanilla flavoring ingredient may comprise ground vanilla beans, vanillin, or other commercially available vanilla flavoring agent.

Preferably, the coffee product includes grain flakes made from wheat, oats, corn, or barley flour, or combinations thereof. Suitable grain flakes are respectively sold under the trade names Wheaties™, Total™, and Corn Flakes™ by General Mills, Inc. of Minneapolis, Minn. and The Kellog Company of Battle Creek, Mich. The grain flakes is a filler which is less expensive than coffee and adds flavor to the resulting brewed coffee beverage. Grain flakes typically have a particle size in the mesh range of about 8 to 16 for standard percolator coffee makers, in the mesh range of about 12 to 24 for automatic drip coffee makers, and in the mesh range of about 20 to 36 for European coffee brewing. The wheat flour is preferably semolina or amaranth flour. While semolina flour is widely known and used in food products, amaranth flour is much less known and used. Amaranth flour originated with the Aztecs who discovered its high nutritional value centuries ago, being high in carbohydrates, providing complete vegetable grain proteins, being rich in calcium, iron, and phosphorus, and being low in fat content. Amaranth flour is commercially available from Arrowhead Mills, Inc. of Hereford Tex.

The ingredients are preferably mixed together to form the coffee product in proportions of between about 35 to 45 volume percent ground roasted coffee, between about 10 to 20 volume percent cocoa, between about 0 to 10 volume percent vanilla flavoring ingredient, and between about to 45 volume percent grain flakes.

The disclosed coffee products may be conventionally packaged in coffee cans, foil bags, pre-made filter packs, and the like and brewed like ground roasted coffee in peculator and drip coffee makers. The disclosed coffee products are typically processed under such sanitary conditions that the originally sterile ingredients are not contaminated and remain sterile following packaging. Alternatively, the disclosed coffee products may be sterilized above 120 degrees C. prior packaging. The packaged coffee product typically has a low moisture content and may be dried to such low moisture content if needed such that no preservatives are needed, though preservatives may be used if so desired depending on the particular composition of the coffee product. The low moisture content also helps to prevent deterioration and caking of the coffee product. Alternatively, the coffee product may be packaged in individual filter bags similar to tea bags with enough coffee product to make one cup when dipped in a cup of hot water.

### EXAMPLE #1

Ground roasted coffee—40 percent

Cocoa—15 percent

Vanilla flavoring ingredient—5 percent

Grain flakes—40 percent

All of the dry ingredients are added to a commercial mixer and mixed, blended, or otherwise combined together in a paddle, drum, screw, plough type mixer into a uniform mixture. If the vanilla flavoring ingredient is liquid, it is sprayed on the mixed dry ingredients along a moving conveyor following removal from the mixer. The spray coated dry ingredients are run through a drying oven to evaporate the liquid carrier such as water. The mixture is then screened using commercial screening equipment to the desired particle size for standard percolator coffee makers, automatic drip coffee makers, or European coffee brewing, and packaged.

The resulting coffee product may be brewed in peculator or drip coffee makers, for example, in a ratio of about one teaspoon of coffee product to each cup of water using conventional brewing techniques to produce a brewed coffee beverage. The coffee beverage has a good rich look and a smoother, pleasantly different flavor.

Any of the disclosed coffee products may optionally include between about 1 to 10 percent of one or more additional flavoring ingredients typically in encapsulated, dry granular, or liquid form of natural or artificial in origin. These flavoring ingredients are preferably mint, cinnamon, peppermint, and maple syrup. Other flavoring ingredients may be used or blended together such as banana, strawberry, cherry, and orange, almond nut, amaraetto, anisette, brandy, cappuccino, cinnamon almond, creme de menthe, grand mariner, pistachio, sambuca, apple, chamomile, cinnamon spice, creme, creme de menthe, french vanilla, Irish creme, kahlua, lemon, macadamia nut, orange leaf, peach, grape, raspberry, chocolate, and the like. Roasted chicory may be added to darken the color and add desirable chicory flavor to the resulting of the coffee beverage.

Any of the disclosed coffee products further may optionally include one or more aroma enhancers such as acetaldehyde, herbs, spices, or mixtures thereof.

Any of the disclosed coffee products still further may include one or more additional ingredients conventionally used in coffee, such as creamers, sugar, honey, and artificial sweeteners. These additional ingredients are typically in dry form to preserve the granular or ground coffee consistency of the coffee product to which coffee users are accustomed. Such creamers include preserved dairy creamers, non-dairy creamers, synthetic and imitation dairy products, non-fat and whole milk solids, and the like. Such artificial sweeteners include saccharin, cyclamates, L-aspartyl-L-phenylalanine lower alkyl ester sweeteners (e.g., aspartame), and the like. Aspartame, for example, may be added in a proportion of about 0.5% percent.

### EXAMPLE #2

Ground roasted coffee—40 percent

Cocoa—15 percent

Vanilla flavoring—4.5-5 percent

Grain flakes—40 percent

Cinnamon—0.5 percent (optional)

Cinnamon is added as an optional flavor ingredient. All of the dry ingredients are added to a commercial mixer and mixed, blended, or otherwise combined together in a paddle, drum, screw, plough type mixer into a uniform mixture. If the vanilla or cinnamon flavoring ingredients are liquid, they are sprayed on the mixed dry ingredients along a moving conveyor following removal from the mixer. The spray coated dry ingredients are run through a drying oven to evaporate the liquid carrier such as water. The mixture is then screened using commercial screening equipment to the desired particle size for standard percolator coffee makers, automatic drip coffee makers, or European coffee brewing, and packaged.

The resulting coffee product may be brewed in peculator or drip coffee makers, for example, in a ratio of about one teaspoon of coffee product to each cup of water using conventional brewing techniques to produce a brewed coffee beverage. The coffee beverage has a good rich look and a smoother, pleasantly different flavor.

### Second Embodiment Brewable Coffee Product

A second embodiment brewable coffee product includes the ground roasted coffee described above, and a plurality of elongate, non-toxic flow-facilitating members adapted to facilitate flow of brewing water through the product during brewing. The flow-facilitating members are typically of a generally cylindrical longitudinal cross-section, being of a length of between about three-eighths and five-eighths inch and a diameter of between about one-thirty-second and three-thirty-second inch, preferably being of a size of about one-half inch long and about one-sixteenth inch in diameter, though variations in size are possible. This elongate configuration allows the brewing water to wick downwardly and flow therealong, while typically slower than pure ground coffee, being faster than pure grain-based brewable products so as to not clog or plug during brewing, particularly within drip coffee makers. The ingredients are typically mixed together in proportions of between about 50 to 70 volume percent ground roasted coffee and between about 30 to 50 volume percent flow-facilitating members to provide proper flow of the brewing water through the coffee product.

The flow-facilitating members are preferably adapted to raise the normally acidic pH of the coffee beverage brewed therewith to provide a less bitter, more pleasing taste. I have discovered that pasta products have acid-neutralizing properties which to my knowledge have never been disclosed before. Example types of such pasta products include spaghetti, macaroni, noodles, and combinations thereof. Preferably, the flow-facilitating members are a pasta product substantially comprised of semolina flour. The preferred pasta product is spaghetti of a diameter of about one-sixteenth inch broken into pieces of about one-half inch long. Also, enriched macaroni products may be used such as Fideo macaroni and melon seed macaroni by Grupo Gamesa, S.A. DE C.V. of Madrid, Spain. It is imported and distributed by Pepsico Foods Imports of Ontario, Canada. The pH of the coffee beverage brewed using the coffee product with macaroni as the flow-facilitating members typically ranges between about 6.0 to 6.8 pH, which is higher than the typical 5.6 to 5.8 pH of conventional brewed coffee.

### EXAMPLE #3

Ground roasted coffee—60 percent

Spaghetti (broken into approximately ½ inch long by 1/16 inch diameter pieces)—40 percent

All of the ingredients are added to a commercial mixer and mixed, blended, or otherwise combined together in a paddle, drum, screw, plough type mixer into a uniform mixture, and packaged. Note that the mixture is typically not screened due to the presence of the flow-facilitating members (spaghetti) which are intentionally much larger than the particles of ground roast coffee.

The resulting coffee product is particularly suited to be brewed in drip coffee makers, for example, in a ratio of about one teaspoon of coffee product to each cup of water using conventional drip brewing techniques to produce a brewed coffee beverage. The coffee beverage has a good rich look and a smoother, pleasantly different flavor, with a natural non-acid taste with a pH of about 6.8 which is almost neutral. I call this coffee beverage Italian Coffee due to the use of spaghetti in the brewing thereof, being more of a “health drink” than conventional brewed coffee due to the less acidic nature thereof. This coffee product is particularly economical due to the low number of ingredients therein.

Therefore, the coffee products of the present invention satisfy the shortcomings of the prior art by providing an improved coffee product for brewing an improved coffee beverage which: 1) facilitates the flow of the brewing water so as not to plug up during brewing in drip coffee makers; and 2) is acid neutralizing to produce a brewed coffee beverage which is naturally non-bitter and an “alkalizing” food rather than an acid-forming food; 3) is made from natural ingredients and thus healthier to drink; 4) is smooth and have a slightly different pleasing flavor; 5) is economical to produce; and 6) has a low number of ingredients; and be packagable in multiple formats such as canisters, foil bags, and single use dunking bags similar to tea bags.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

1. (canceled)

2. (canceled)

3. (canceled)

4. (canceled)

5. (canceled)

6. (canceled)

7. (canceled)

8. (canceled)

9. (canceled)

10. (canceled)

11. A brewable coffee product usable to produce a coffee beverage, comprising:
ground roasted coffee; and
a plurality of elongate, non-toxic flow-facilitating members adapted to facilitate flow of brewing water through said product during brewing.

12. A brewable coffee product usable to produce a coffee beverage, comprising:
ground roasted coffee; and
a plurality of elongate, non-toxic flow facilitating members comprised of a pasta product adapted to facilitate flow of brewing water through said product during brewing.

13. A coffee product in accordance with claim 12, wherein the pasta product is substantially comprised of Semolina flour.

14. A coffee product in accordance with claim 12, wherein the pasta product substantially comprises a type chosen from the group consisting of spaghetti, macaroni, noodles, and a combination of at least two thereof.

15. A brewable coffee product usable to produce a coffee beverage, comprising:
ground roasted coffee;
a plurality of elongate, non-toxic flow-facilitating members adapted to facilitate flow of brewing water through said product during brewing; and
wherein there is between about 50 to 70 volume percent ground roasted coffee and between about 30 to 50 volume percent flow-facilitating members, and said flow-facilitating members comprise spaghetti of a length of between about three-eighths and five-eighths inch and a diameter of between about one-thirty-second and three-thirty-second inch.

16. A coffee product in accordance with claim 11, wherein the flow-facilitating members are adapted to raise the pH of a coffee beverage brewed therewith to reduce acidity thereof.

17. A coffee product in accordance with claim 16, wherein the flow-facilitating members are adapted to raise the pH of the coffee beverage prepared using the product between about 6.0 to 6.8 pH.

18. (canceled)

19. (canceled)

20. (canceled)

21. (canceled)

22. (canceled)

23. A brewable coffee product usable to produce a coffee beverage, comprising:
ground roasted coffee; and
a plurality of elongate, non-toxic flow-facilitating members adapted to facilitate flow of brewing water through said product during brewing, said flow facilitating members are a pasta product substantially comprising a type chosen from the group consisting of spaghetti, macaroni, noodles, and a combination of at least two thereof; and
wherein there is between about 50 to 70 volume percent ground roasted coffee and between about 30 to 50 volume percent flow-facilitating members, and said flow-facilitating members are adapted to raise the pH of a coffee beverage brewed therewith to reduce acidity thereof.

24. A coffee product in accordance with claim 23, wherein the pasta product is substantially comprised of Semolina flour.

25. A coffee product in accordance with claim 23, wherein the pH of the coffee beverage prepared using the product ranges between about 6.0 to 6.8 pH.

26. A coffee product in accordance with claim 12, further comprising:
cocoa; and
a vanilla flavoring ingredient.

27. A coffee product in accordance with claim 12, further comprising flour separate from the pasta product.

28. A coffee product in accordance with claim 27, wherein the flour substantially comprises a type chosen from the group consisting of amaranth and semolina.

29. A coffee product in accordance with claim 27, wherein the flour is in the form of grain flakes.

30. A coffee product in accordance with claim 29, wherein there is between about 35 to 45 volume percent ground roasted coffee, between about 10 to 20 volume percent cocoa, between about 0 to 10 volume percent vanilla flavoring ingredient, and between about 35 to 45 volume percent grain flakes.

31. A coffee product in accordance with claim 29, wherein the grain flakes are of a type chosen from the group consisting of wheat, oats, corn, barley, and combinations thereof.

32. A coffee product in accordance with claim 26, further comprising at least one additional flavoring ingredient chosen from the group consisting of mint, cinnamon, peppermint, and maple syrup.

33. A coffee product in accordance with claim 26, further comprising an additional ingredient chosen from the group consisting of cream, sugar, honey, and artificial sweeteners.

34. A coffee product in accordance with claim 26, wherein the coffee is of at least one type chosen from the group consisting of Columbian, French Roast, Arabica, and Robustas.

35. A coffee product in accordance with claim 26, individually packaged for single cup dipping.

36. A coffee product in accordance with claim 12, further comprising:
cocoa;
a vanilla flavoring ingredient; and
flour in the form of grain flakes.

37. A coffee product in accordance with claim 36, wherein the grain flakes are of a type chosen from the group consisting of wheat, oats, corn, barley, and combinations thereof, and there is between about 35 to 45 volume percent ground roasted coffee, between about 10 to 20 volume percent cocoa, between about 0 to 10 volume percent vanilla flavoring ingredient, and between about 35 to 45 volume percent grain flakes.

38. A coffee product in accordance with claim 36, wherein the flour substantially comprises a type chosen from the group consisting of amaranth and semolina.

39. A coffee product in accordance with claim 36, further comprising at least one additional flavoring ingredient chosen from the group consisting of mint, cinnamon, peppermint, and maple syrup.

40. A coffee product in accordance with claim 36, individually packaged for single cup dipping.
